(19) United States
(12) Patent Application Publication
(10) Pub. No.: US 2016/0069768 A1
(43) Pub. Date: Mar. 10, 2016

(54) METHOD FOR ESTIMATING A TORQUE GENERATED BY AN INTERNAL COMBUSTION ENGINE

(71) Applicant: SCANIA CV AB, Södertälje (SE)

(72) Inventors: Björn JOHANSSON, Johanneshov (SE); Anders LARSSON, Tullinge (SE)

(21) Appl. No.: 14/889,115

(22) PCT Filed: Jun. 2, 2014
(86) PCT No.: PCT/SE2014/050666

§ 371 Date: Nov. 4, 2015

(30) Foreign Application Priority Data
Jun. 10, 2013 (SE) 1350707-4

(51) Int. Cl. G01L 25/00; F02D 41/04; G01L 3/24

(52) U.S. Cl. CPC G01L 25/003; G01L 3/24; F02D 41/04

(57) ABSTRACT

Method for estimation of a mean torque generated by a combustion engine with at least two cylinders, comprising to generate an engine speed vector, wherein several measuring values representing the instantaneous engine speed of the engine, are registered, to determine the respective n:th highest and the n:th lowest value of the engine speed vector, where 2≦n≦x/2, where x is the number of measuring values associated with the respective cylinder in the engine speed vector, to calculate the difference between the two values determined in step b, to generate a signal E representing the differences obtained as function of time, and to estimate the torque generated by the motor as a function T dependent at least on the signal E.

### FIELD OF THE INVENTION

The present invention pertains to a method for estimation of a mean torque generated by a combustion engine. The invention is particularly, but not exclusively, focused on the performance of such a method in motor vehicles in the form of wheeled commercial vehicles, especially heavy goods vehicles, such as trucks, tractors and buses. Mean torque here means a mean torque generated during at least one combustion cycle in the combustion engine.

There are several reasons why it is interesting to know, all the time, what actual torque a combustion engine generates. For example, one may need to control that the combustion engine generates the torque which it is designed to generate according to specifications. If the engine does not generate the torque which it is intended to generate, it is possible, by knowing the torque which is generated, to adapt the fuel injection time in order to thus control the torque. One may also need to control the torque in order to be able to, during some shifting procedures, engage and disengage gears with good comfort. With a future increase in fuel flora of varying energy content, it will become increasingly important to be able to estimate the torque generated by the engine, among others in order to make vehicles driven by combustion engines less jerky, and thus more comfortable.

### BACKGROUND TECHNOLOGY

There are several prior art methods to estimate a torque from a combustion engine.

US20030167118 describes such a method, where measurements of the engine's engine speed are used in order to estimate the engine's torque with the help of the Fourier transform.

EP1559898 describes a method for estimation of torque from a combustion engine, where an estimated engine speed signal is produced via a trigonometric model. From the estimated engine speed signal, the amplitude of the engine speed fluctuations is obtained, which in turn are used to estimate the torque.

US2009/0132182 describes a method to produce a value representative of the mean torque generated by the engine during a sampling period. A mean value for the engine's engine speed is calculated during the sampling period, and this value is then used in a polynomial to obtain a value for the mean torque. Fourier series, or the Fourier transform, are used to determine the power contribution from a certain cylinder.

US2008/0319725 describes a method to first calculate the rotational speed of a combustion engine and then use the calculated rotational speed's Fourier coefficient in order to obtain a mean torque generated by each cylinder in the engine.

### SUMMARY OF THE INVENTION

The objective of the present invention is to present a method to estimate a mean torque generated by a combustion engine, which method is at the same time sufficiently reliable to provide an estimate which is proximate to the actually generated torque, and sufficiently robust and uncomplicated to be used in order to estimate the torque in real time in for example a vehicle which is driven by the engine.

This objective is achieved according to the invention by providing a method for estimating a mean torque generated by a combustion engine with at least two cylinders, which method comprises the steps to:
a) generate an engine speed vector, where several measuring values are registered during at least one part of a combustion cycle in the engine, wherein each measuring value is associated with one of the engine's cylinders and represents the engine's instantaneous speed at the respective measuring time,
b) determine the engine speed vector's n:th highest and n:th lowest value, respectively, associated with the respective cylinder, where 2≦n≦x/2, where x is the number of measuring values in the engine speed vector associated with the respective cylinder,
c) calculate, for the respective cylinder, the difference between the two values determined in step b,
d) generate a signal E representing the differences obtained in step c as a function of time,
e) estimate the torque generated by the engine in step a as a function T depending on at least the signal E generated in step d.

With the method according to the invention, a filtered amplitude of the engine speed fluctuations in the engine is thus used during a combustion cycle, in order to estimate the mean torque generated by the engine. At the calculation of the engine speed amplitude, the respective n−1 highest and lowest values are removed from the engine speed vector's measuring values associated with the respective cylinder. In this manner, the method becomes less sensitive to diverging values and thus more robust than if the respective highest and lowest value were used. Preferably, the method is carried out with 2≦n≦x/4 in order not to lose too much information. With the method according to the invention, no extra sensors are required, but a good estimation of the torque generated may be achieved only with the help of an engine speed sensor, which must exist anyway, among others in order to determine when the fuel injection should occur, in order to maintain the idle speed and at shifting procedures.

According to one embodiment the method is carried out with the help of a control device, wherein the function T is a polynomial whose coefficients are determined at an initial calibration of said control device. A polynomial provides a relatively simple and good estimation of the generated torque. Since the coefficients are determined at an initial calibration the algorithm used to estimate the torque becomes robust. It is possible to make this calibration with the help of the newly manufactured engine, but it is more efficient to determine the coefficients with the help of a development engine which is identical to the subsequently serially manufactured engines, whose torque must be estimated. The calibration may also be made theoretically with the help of e.g. a calculation model.

According to a specific variant of this embodiment, the initial calibration of the control device comprises carrying out said steps a-e, and the additional steps:
f) to measure a torque generated by the engine simultaneously with step a,
g) to select coefficients of a polynomial by way of curve fitting, so that the polynomial describes the in step f measured generated torque as a function depending on at least the signal E.

This calibration method gives an expression which may describe the torque generated by the engine arbitrarily well. The installation used for the measurement of the generated torque should not be too unlike the installation which the engine then will be used in, since the engine speed variations may otherwise differ from how they appear when the engine is mounted in its site of use, e.g. in a vehicle.

According to another embodiment the torque generated by the engine is estimated in step e as a function T=α+βE, where α and β are coefficients and where E is the signal generated in step d. The torque is estimated in this manner with a simple, and, in terms of calculation, cheap and robust expression.

According to another embodiment a mean engine speed signal V is generated, representing the engine's mean speed ω̅, and the torque generated by the engine is estimated in step e as a function T depending on the mean engine speed signal V. According to one variant of this embodiment, the torque generated by the engine is estimated as a function T=α+βE+γV+ηEV, where α, β, γ and η are coefficients, where E is the signal generated in step d and where V is the mean engine speed signal. In this manner an even better estimation of the engine's torque may be made.

According to another embodiment the engine's charge air pressure P is measured, and the torque generated by the engine is estimated in step e as a function T depending on the engine's charge air pressure. If it is possible to make a reliable charge pressure measurement, this may give a good estimate of the generated torque, which may be less sensitive to potential measuring faults in the engine speed measurement and to the impact from the rest of the drive line, than if only the engine speed and the engine speed amplitude were used for the estimation of the torque.

According to one embodiment the engine speed vector's length corresponds to the number of measuring occasions during a combustion cycle in the engine. This allows other analyses of the measured engine speeds to be carried out.

According to another embodiment the number of crank angle degrees θ between each measuring time during a combustion cycle in the engine is constant. This provides an uncomplicated interpretation of the engine speed measuring values and simplifies the filtration and generation of the signal E.

According to another embodiment the function T is selected depending on the gear which is used to drive a vehicle operated by the combustion engine. The coefficients in a polynomial expression may for example be selected differently depending on the gear. By detecting which gear is used, the coefficients may be selected so that the polynomial expression describes the torque as well as possible. This is particularly useful in applications where the drive line's dynamics are of great significance.

According to another embodiment, the function T is selected depending on the ambient parameters comprising ambient pressure and/or temperature and/or fuel type. For example, different coefficients in a polynomial expression may be selected depending on whether the engine is driven with petrol, ethanol, diesel, bio-diesel or gas. This may also provide a better estimate of the torque than if the same function is selected independently of the prevailing ambient parameters.

According to another embodiment, the differences calculated in step c form a signal D as a function of a crank angle, which signal D is filtered through a low pass filter or a median filter to form a signal H. According to one variant of this embodiment, the signal E is generated by re-sampling the signal H formed in step c with respect to time. The filtration reduces the bandwidth of the signal D and reduces the risk of folding effects when this signal is then re-sampled with respect to time. It also reduces noise levels. The bandwidth of the filter should thus be selected so that folding effects are avoided when the desired sampling frequency is used to re-sample with respect to time. A typical sampling frequency is between 1-100 ms, preferably between 5-20 ms. For example, a sampling frequency of 10 ms is used.

According to another aspect of the invention, the objective is achieved with a computer program which may be downloaded to an internal memory of a computer, comprising software to control the steps according to the method suggested above, when said program is executed on a computer.

According to another aspect of the invention, the objective is achieved with a computer program product comprising a data storage medium which is readable by a computer, the computer program code of a computer program according to the above being stored on the data storage medium.

According to another aspect of the invention, the objective is achieved through an electronic control device comprising an execution means, a memory connected to the execution means and a data storage medium connected to the execution means, the computer program code in a computer program according to the above being stored on said data storage medium.

According to another aspect of the invention, the objective is achieved through a motor vehicle comprising an electronic control device according to the above.

Other advantageous features of the invention and advantages of the latter are set out in the description below.

### BRIEF DESCRIPTION OF THE DRAWINGS

The invention is described below with the help of example embodiments, with reference to the enclosed drawings, where

FIGS. 1a-b shows schematically a combustion engine's engine speed as a function of crank angle,

FIG. 2 shows the estimated torque and measured torque for a combustion engine as a function of time, and

FIG. 3 is a schematic diagram of a control device for implementation of a method according to the invention.

### DETAILED DESCRIPTION OF EMBODIMENTS ACCORDING TO THE INVENTION

The method according to the invention is carried out for a combustion engine with several cylinders. In such a combustion engine each cylinder contributes to the combustion engine's total torque with a net torque. During a stationary or quasi-stationary combustion cycle in the engine, the instantaneous torque varies during the entire time, as the combustion engine generates around a mean torque M̅. The torque generated by the engine may thus be divided up into a constant mean torque M̅ and a variable torque Mᵥₐᵣ:

M= M̅+Mᵥₐᵣ. (1)

At a low load the engine generates a low mean torque M̅ and the torque variation amplitude A_{M}, which is the amplitude with which the torque varies during a combustion cycle, is also low. At a high load the opposite applies, i.e. a high mean torque M̅ and a high torque variation amplitude A_{M}. The torque variation amplitude A_{M} is proportionate to the mean torque M̅.

In stationary conditions the mean torque Lₘ, of the engine is the same as the generated mean torque M̅:

Lₘ= M̅ (2)

Simplified, the engine may during quasi-stationary conditions be described by the differential equation

$$\begin{matrix}J \dot{ω} = \overline{M} + {M}_{var} - {L}_{m} = {M}_{var} , & ( 3 ) \\ \frac{d ω}{d t} = \frac{1}{J} {M}_{var} , & ( 4 )\end{matrix}$$

where ω is the engine's speed. The engine speed may also be expressed as

$$ω = \frac{d θ}{d t} , \qquad ( 5 )$$

where θ is the crank angle and t is time. If the engine speed is derived with respect to time, then

$$\frac{d ω}{d t} = \frac{d ω}{d θ} \frac{d θ}{d t} = \frac{d ω}{d θ} ω , \qquad ( 6 )$$

is obtained which gives

$$\frac{d ω}{d θ} = \frac{1}{J} \cdot \frac{1}{ω} {M}_{var} . \qquad ( 7 )$$

For a four-stroke engine Mᵥₐᵣ may be described approximately as

Mᵥₐᵣ=A_{M} cos(Nθ/2+φ) (8)

where N is the number of cylinders and φ is a phase offset. By integrating between θ₁ and θ₂

$${\int }_{{θ}_{1}}^{{θ}_{2}} \frac{d ω}{d θ} d θ = \frac{1}{J} {\int }_{{θ}_{1}}^{{θ}_{2}} \frac{1}{ω} {M}_{var} d θ \approx \frac{1}{J \overline{ω}} {\int }_{{θ}_{1}}^{{θ}_{2}} {M}_{var} d θ = \frac{{A}_{M}}{J \overline{ω}} {\int }_{{θ}_{1}}^{{θ}_{2}} cos ( N θ / 2 + ϕ ) d θ , \qquad ( 9 )$$

is obtained, which applies approximatively, since ω does not fluctuate so much and is therefore replaced with the mean engine speed ω̅. Thus, one obtains that

$$ω ( {θ}_{2} ) - ω ( {θ}_{1} ) = \frac{2 {A}_{M}}{NJ \overline{ω}} ( sin ( N {θ}_{1} / 2 + ϕ ) - sin ( N {θ}_{2} / 2 + ϕ ) ) . \qquad ( 10 )$$

Through suitable selection of θ₁ and θ₂ approximatively is obtained

A_{M}= ω̅ψA_{ω} (11)

where A_{ω} is the combustion engine's engine speed amplitude and ψ is a constant. Since the mean torque is proportionate to the torque amplitude, the combustion engine's mean torque generated during a combustion cycle may thus be estimated based on the engine's engine speed amplitude A_{ω} and mean engine speed ω̅.

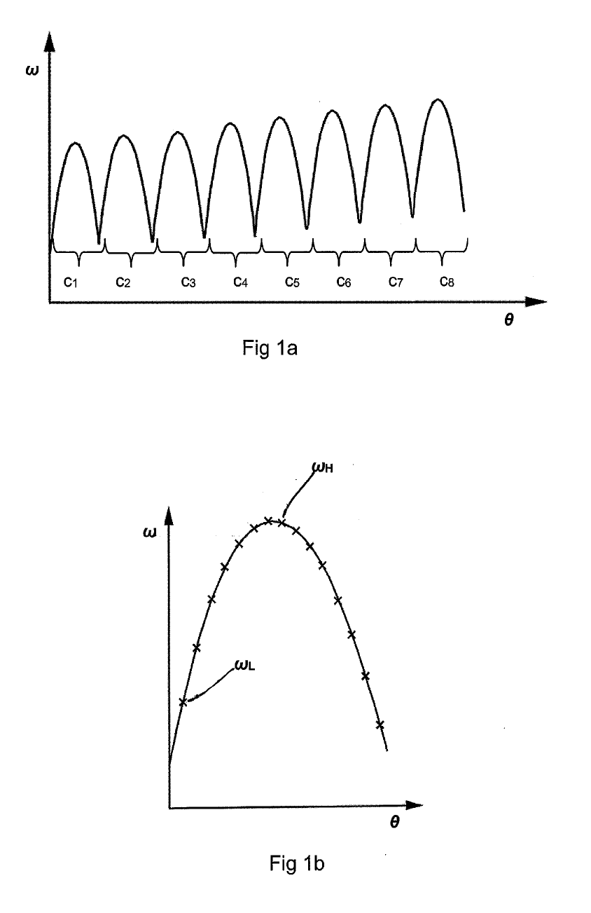

In FIG. 1a a schematic diagram is displayed for an eight-cylinder engine, where the engine speed ω of a combustion engine is displayed as a function of the crank angle θ. Each cylinder c₁, c₂, c₃, c₄, c₅, c₆, c₇, c₈ gives rise to an engine speed fluctuation. The number of engine speed fluctuations, and thus also torque fluctuations, which the combustion engine generates during a combustion cycle is therefore identical to the number of cylinders. An eight cylinder combustion engine thus has eight fluctuations per combustion cycle, wherein each fluctuation is associated with one of the cylinders as displayed in FIG. 1a. For a four-stroke engine a combustion cycle comprises 720 crank angle degrees.

In the method according to the invention, the engine's instantaneous engine sped is measured at a number of occasions per combustion cycle. This preferably is effected by an engine speed sensor detecting markings on the engine's flywheel, which markings are usually located at a constant number of crank angle degrees' interval, dθ. By checking the time it takes for the flywheel to rotate dθ crank angle degrees, the instantaneous engine speed at a certain crank angle θ is obtained. The number of measuring values associated with the torque contribution from a cylinder is provided by

$$x = \frac{180 \cdot m}{N \cdot d θ} , \qquad ( 12 )$$

where m is the number of strokes of the engine and N is the number of cylinders. For a four stroke engine with eight cylinders and dθ=6°, 15 measuring values per cylinder are thus obtained during a combustion cycle, as displayed schematically for a cylinder in FIG. 1b. These measuring values are stored in an engine speed vector, which may be in the form of a circular buffer wherein, when the buffer has been filled, one starts all over again, writing over previous values. In order to determine an engine speed amplitude A_{ω} for each cylinder, one disregards the n−1 highest and lowest values, where 2≦n≦x/2, and the difference between the subsequently remaining highest and lowest values are calculated. This series of differences forms a filtered engine speed amplitude A_{ω,f}. Which value is selected for n depends on the number of measuring values per cylinder. In the case illustrated in FIG. 1b, n is set at 2, wherein the second highest value ω_{H} and the second lowest value ω_{L} are used to calculate the filtered engine speed amplitude. A suitable value for n may in the above mentioned example, i.e. for a four stroke engine with eight cylinders and dθ=6°, be 2-3, wherein the respective 1-2 highest and lowest engine speed values for each cylinder are disregarded. The more values are removed, the less sensitive the estimated torque for diverging measuring values becomes, while at the same time information is lost and there is a risk that the engine speed amplitude is calculated at too low a value.

When the filtered engine speed amplitude A_{ω,f} has been determined, a signal D is formed, describing this amplitude as a function of crank angle θ. This signal is filtered through a linear filter such as a low pass filter or a non-linear filter in the form of e.g. a median filter, which reduces the bandwidth of the signal, for the formation of a new signal H. For example, a band pass filter in the form of an IIR-filter with suitably selected filter coefficients may be used for the formation of the signal H. The signal H is re-sampled with respect to time in a subsequent step, for the formation of the signal E. A typical sampling frequency is ms, but other frequencies may also be used. The now obtained signal E describes the combustion engine's engine speed variations as a function of time.

In order to estimate the mean torque based on this signal E a model is used. A simple model for the estimated torque T is

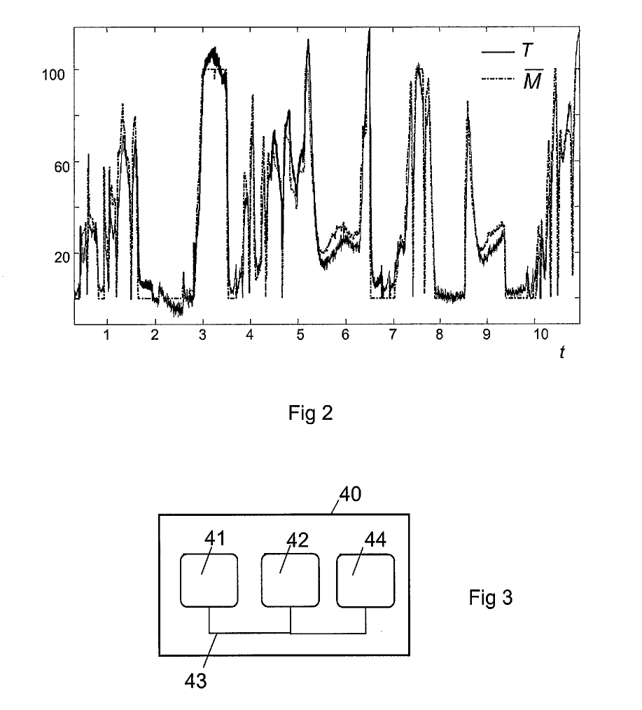

T=α+β·E, (13)

where α and β are coefficients. FIG. 2 shows a torque estimate T, obtained with the help of this simple model, as a function of normalised time t together with a measured mean torque for the above mentioned eight cylinder combustion engine. The estimated torque T is shown as a solid line and the measured generated mean torque M̅ is shown as a dashed line, both displayed as a percentage of the maximum torque.

Alternative models that may be used to estimate torque are for example

T=α+β·E+γ·V, (14)

where V is a signal representing the calculated mean engine speed for a cylinder as a function of time, and where γ is a coefficient. The signal V may e.g. be obtained by low pass filtering the crank angle based engine speed signal, which gives a mean engine speed, and then re-sampling the mean engine speed obtained with respect to time. The mean engine speed may suitably be calculated for the same period as the mean torque.

Another model is

T=α+β·E+γ·V+μ·E·V, (15)

where μ is yet another coefficient. In order to further improve the estimation, other operating characteristics may be included in the model, such as the charge pressure P. Such a model may be

T=α+β·E+λ·P, (16)

where λ is a coefficient. The estimation in this case becomes dependent on the reliability of the charge pressure measurement. In addition, more sensors are required than in case only engine speed and engine speed amplitude are used to estimate the torque. Naturally, other operating characteristics may be used in the model, as well as other combinations and higher orders of the operating characteristics included, than those mentioned above. Examples of other operating characteristics which may be used are exhaust temperature, exhaust collector pressure and measured or estimated fuel amount injected into the engine.

The coefficients in the above mentioned models may be determined at an initial calibration of a control device, which is used for the estimation of the engine's torque during the operation of the engine. At this calibration, the above described steps are carried out, i.e. the engine's engine speed is measured, a filtered engine speed amplitude is determined and a time sampled signal E, which describes this amplitude, is created. Simultaneously with the engine speed measurements the torque M generated by the engine is also measured. Coefficients of a polynomial are selected through curve fitting, so that the polynomial describes the measured generated torque as a function depending on at least the signal E. The coefficients may preferably be selected by minimising the smallest square error in the function T in relation to the measured torque.

In certain applications the drive line's dynamics are of great significance, and the coefficients in the expression for T may then be selected depending on which gear is used. In these cases a parameter from a control device for the gearbox may be read, in order to determine which coefficients should be selected. Alternatively the gear may be selected based on measurements of speed and engine speed, or in another applicable manner. The method is well suited for implementation during control of combustion engines which are used in the operation of heavy goods vehicles. These engines are usually operated with a narrower engine speed range than engines in for example passenger cars. The highest engine speeds are usually in the range of 2000 rpm in such a vehicle, and at such engine speeds the engine speed signal may be measured with a good resolution and may therefore be treated directly without having to be estimated first.

A computer program code for the implementation of a method according to the invention is suitably included in a computer program, loadable into the internal memory of a computer, such as the internal memory of an electronic control device of a motor vehicle. Such a computer program is suitably provided via a computer program product comprising a data storage medium readable by an electronic control device, the data storage medium of which has the computer program stored thereon. Said data storage medium is e.g. an optical data storage medium in the form of a CD-ROM, a DVD, etc., a magnetic data storage medium in the form of a hard disk drive, a floppy disc, a cassette, etc., or a Flash memory or a ROM, PROM, EPROM or EEPROM type memory.

FIG. 3 illustrates schematically an electronic control device 40 comprising execution means 41, such as a central processor unit (CPU), for the execution of a computer software. The execution means 41 communicates with a memory 42, e.g. a RAM memory, via a data bus 43. The control device 40 also comprises a data storage medium 44, e.g. in the form of a Flash memory or a ROM, PROM, EPROM or EEPROM type memory. The execution means 41 communicates with the data storage means 44 via the data bus 43. A computer program comprising computer program code for the implementation of a method according to the invention is stored on the data storage medium 44.

The invention is not limited in any way to the embodiments described above, but numerous possible modifications thereof should be obvious to a person skilled in the area, without such person departing from the spirit of the invention as defined by the appended claims.

1. Method for estimation of a mean torque generated by a combustion engine with at least two cylinders, comprising:
a) generating an engine speed vector, wherein several measuring values are registered during at least one part of a combustion cycle in the engine, wherein each measuring value is associated with one of the engine's cylinders and represents the engine's instantaneous speed at the respective measuring time;
b) determining the engine speed vector's n:th highest and n:th lowest value, respectively, associated with the respective cylinder, where 2≦n≦x/2, where x is the number of measuring values in the engine speed vector associated with the respective cylinder;
c) calculating the difference between the two values determined at step b for the respective cylinder;
d) generating a signal E representing the differences obtained in step c as a function of time; and
e) estimating the torque generated by the engine in step a as a function T depending on at least the signal E generated at step d.

2. A method according to claim 1, wherein said method it is carried out with the help of a control device, wherein the function T is a polynomial, whose coefficients are determined at an initial calibration of said control device.

3. A method according to claim 2, wherein the initial calibration of the control device comprises carrying out said steps a-e, and the additional steps:
f) measuring a torque generated by the engine, simultaneously with step a; and
g) selecting coefficients of a polynomial by way of curve fitting, so that the polynomial describes the in step f measured generated torque as a function depending on at least the signal E.

4. A method according to claim 1, wherein the torque generated by the engine is estimated in step e as a function T=α+βE, where α and β are coefficients and wherein E is the signal generated at step d.

5. A method according to claim 1, wherein a mean engine speed signal V representing the engine's mean engine speed ω̅ is generated, and that the torque generated by the engine in step e is estimated as a function T depending on the mean engine speed signal V.

6. A method according to claim 5, wherein the torque generated by the engine is estimated as a function T=α+βE+γV+ηEV, where α, γ and η are coefficients, where E is the signal generated in step d and where V is the mean engine speed signal.

7. A method according to claim 1, wherein the engine's charge air pressure P is measured and in that the torque generated by the engine in step e is estimated as a function T depending on the charge air pressure.

8. A method according to claim 1, wherein the engine speed vector's length corresponds to the number of measuring occasions during a combustion cycle in the engine.

9. A method according to claim 1, wherein a number of crank angle degrees θ between each measuring occasion during a combustion cycle in the engine is constant.

10. A method according to claim 1, wherein the function T is selected depending on the gear used to drive a vehicle which is driven by the combustion engine.

11. A method according to claim 1, wherein the function T is selected depending on the ambient parameters comprising ambient pressure and/or temperature and/or fuel type.

12. A method according to claim 1, wherein the differences calculated in step c form a signal D as a function of the crank angle, which signal D is filtered through a low pass filter or median filter to form a signal H.

13. A method according to claim 12, wherein in step d the signal E is generated by re-sampling the signal H formed in step c with respect to time.

14. A computer program product located on a non-transitory computer readable medium, where the computer program product is used for estimation of a mean torque generated by a combustion engine with at least two cylinders, wherein said computer program product comprises instructions for operation by one or more computing devices to cause said one or more computing devices to:
a) generate an engine speed vector, wherein several measuring values are registered during at least one part of a combustion cycle in the engine, wherein each measuring value is associated with one of the engine's cylinders and represents the engine's instantaneous speed at the respective measuring time;
b) determine the engine speed vector's n:th highest and n:th lowest value, respectively, associated with the respective cylinder, where 2≦n≦x/2, where x is the number of measuring values in the engine speed vector associated with the respective cylinder;
c) calculate the difference between the two values determined at operation b for the respective cylinder;
d) generate a signal E representing the differences obtained in operation c as a function of time; and
e) estimate the torque generated by the engine in operation a as a function T depending on at least the signal E generated at operation d.

15. (canceled)

16. An electronic control system comprising:
at least one computer processing device;
a memory connected to the at least one computer processing device; and
a data storage medium connected to the at least one computer processing device, comprising a computer program product located on non-transitory computer readable medium, where the computer program product is used for estimation of a mean torque generated by a combustion engine with at least two cylinders, wherein said computer program product comprises instructions for operation by the one or more computing devices to cause the one or more computing devices to:
a) generate an engine speed vector, wherein several measuring values are registered during at least one part of a combustion cycle in the engine, wherein each measuring value is associated with one of the engine's cylinders and represents the engine's instantaneous speed at the respective measuring time;
b) determine the engine speed vector's n:th highest and n:th lowest value, respectively, associated with the respective cylinder, where 2≦n≦x/2, where x is the number of measuring values in the engine speed vector associated with the respective cylinder;
c) calculate the difference between the two values determined at operation b for the respective cylinder;
d) generate a signal E representing the differences obtained in operation c as a function of time; and
e) estimate the torque generated by the engine in operation a as a function T depending on at least the signal E generated at operation d.

17. Motor vehicle comprising an electronic control system, wherein the electronic control system comprises:
at least one computer processing device;
a memory connected to the at least one computer processing device; and
a data storage medium connected to the at least one computer processing device, comprising a computer program product located on non-transitory computer readable medium, where the computer program product is used for estimation of a mean torque generated by a combustion engine with at least two cylinders, wherein said computer program product comprises instructions for operation by the one or more computing devices to cause the one or more computing devices to:
a) generate an engine speed vector, wherein several measuring values are registered during at least one part of a combustion cycle in the engine, wherein each measuring value is associated with one of the engine's cylinders and represents the engine's instantaneous speed at the respective measuring time
b) determine the engine speed vector's n:th highest and n:th lowest value, respectively, associated with the respective cylinder, where 2≦n≦x/2, where x is the number of measuring values in the engine speed vector associated with the respective cylinder;
c) calculate the difference between the two values determined at operation b for the respective cylinder;
d) generate a signal E representing the differences obtained in operation c as a function of time; and
e) estimate the torque generated by the engine in operation a as a function T depending on at least the signal E generated at operation d.
